(19) United States
(12) Patent Application Publication
(10) Pub. No.: US 2025/0111378 A1
(43) Pub. Date: Apr. 3, 2025

(54) CREDENTIAL SHARING BETWEEN DEVICES

(71) Applicant: Apple Inc., Cupertino, CA (US)

(72) Inventors: Rohit SURESH, Fremont, CA (US); Abde N. FARUQUI, San Jose, CA (US); Caroline TEICHER, Scarsdale, NY (US); Frank A. VAN DEN BERG, San Jose, CA (US); Rahul SARNA, Sunnyvale, CA (US); Richard W. HEARD, San Francisco, CA (US); Shashidhar SHENOY, San Jose, CA (US); Yousuf H. VAID, Fremont, CA (US)

(21) Appl. No.: 18/783,397

(22) Filed: Jul. 24, 2024

Related U.S. Application Data
(60) Provisional application No. 63/541,760, filed on Sep. 29, 2023.
(60) Provisional application No. 63/541,762, filed on Sep. 29, 2023.

(51) Int. Cl. G06Q 20/40

(52) U.S. Cl. CPC G06Q 20/409; G06Q 20/405

(57) ABSTRACT

An electronic device may provide a credential to another electronic device. The credential may allow the other electronic device to perform a transaction. In some instances, the electronic devices may be in proximity to each other, and the proximity may be used to authorize use of the credential on the other device. Further, a user of the electronic device that provides the credential may set one or more conditions on the use of credential by the other device.

### CROSS REFERENCE TO RELATED APPLICATION(S)

The present application claims the benefit of U.S. Provisional Application No. 63/541,760, entitled “CREDENTIAL SHARING BETWEEN DEVICES”, filed Sep. 29, 2023, and U.S. Provisional Application No. 63/541,762, entitled “CREDENTIAL SHARING BETWEEN DEVICES”, filed Sep. 29, 2023, the entirety of which is incorporated herein for reference.

### TECHNICAL FIELD

This application is directed to using a credential on a device, and more particularly, sharing access of a credential from one device to another device based in part on proximity between the devices.

### BACKGROUND

A user may store a credential associated with an account own or managed by the user's electronic device. Using the electronic device, the user may perform a transaction (e.g., purchase an item) using the credential. If another user desires to use the credential, the user may be required provide the user's device to the other user. Alternatively, the user may be required to provide the other user with a credit card, debit card, or the like.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment of a payment processing system in which a credential may be shared between devices, in accordance with aspects of the present disclosure.

FIG. 2 illustrates a block diagram of an example of an electronic device that may be used to provide and/or transact with a credential, in accordance with aspects of the present disclosure.

FIG. 3 illustrates a block diagram of an example of an electronic device used to provide a credential, in accordance with aspects of the present disclosure.

FIG. 4 illustrates a block diagram of an example of an electronic device providing a credential to an electronic device, in accordance with aspects of the present disclosure.

FIG. 5 illustrates a flow diagram showing an example of a process that may be performed for providing access to a credential for a device, in accordance with implementations of the subject technology.

FIG. 6 illustrates a flow diagram showing an alternate example of a process that may be performed for providing access to a credential for a device, in accordance with implementations of the subject technology.

FIG. 7 illustrates a flow diagram showing an alternate example of a process that may be performed for providing access to a credential for a device, in accordance with implementations of the subject technology.

FIG. 8 illustrates a flow diagram showing an example of a process that may be performed for obtaining access to a credential for a device, in accordance with implementations of the subject technology.

FIG. 9 illustrates a flow diagram showing an alternate example of a process that may be performed for obtaining access to a credential for a device, in accordance with implementations of the subject technology.

FIG. 10 illustrates a flow diagram showing an alternate example of a process that may be performed for obtaining access to a credential for a device, in accordance with implementations of the subject technology.

FIG. 11 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to sharing a credential (or credentials) between devices. In one or more implementations, an electronic device (e.g., a first electronic device) includes a credential used to perform a transaction. As a non-limiting example, the credential may be associated with an account (e.g., credit card, debit card, or the like) owned or managed by a user and stored on a digital wallet of the first electronic device, such as in the form of a credential provisioned on a secure element of the first electronic device. In some instances, the user may permit another user to use the credential on another device (e.g., a second electronic device), and share, via the first electronic device, the credential with the second electronic device.

In some instances, the second electronic device may not be permitted to use the credential until or unless the first and second electronic devices are within proximity to each other, with the proximity determined by, for example, wireless communication (e.g., BLUETOOTH®) used by the first and second electronic devices to detect each other. Moreover, the credential may be provisioned on a secure element of the second electronic device prior to usage of the credential by the second electronic device. Beneficially, the user of the second electronic device can use the credential on the second electronic device to perform a transaction without having to use the first electronic device and without requiring the user of the first electronic device to be physically present for the user of the second electronic device to perform the transaction. Moreover, based in part on the proximity between the users, and in particular between the first and second electronic devices, the user of the first electronic device that provides the credential may experience an enhanced level of security with respect to user's credential being used on another device. Additionally, the user of the second electronic device may not be required to have an account associated with the credential in order to perform the transaction.

Additionally, in one or more implementations, the user of the first electronic device (e.g., first user) may add the user of the second electronic device (e.g. second user) and/or the second electronic device to an account (e.g., family account, shared account) stored remotely on a server (e.g., in an encrypted form) that includes a stored list of users and their respective devices. By adding the second user and the second electronic device to the account, the first user may use the first electronic device to select the second user as well as a particular device (e.g., the second electronic device) for providing access to the credential. Accordingly, the first user may exercise additional control over sharing the credential by limiting access to the credential to one or more users and/or devices registered to the account.

In one or more implementations, the first user may use the first electronic device to place one or more conditions on use of the credential by the second user on the second electronic device. For example, the first user may place a transaction limit (e.g., spending limit) on the credential using the first electronic device, thus limiting the second user to a transaction (or transactions) on the second electronic device that is not greater the transaction limit. As non-limiting examples, other conditions that may be applied to the credential for use by the second electronic device may include a time duration (e.g., time limit) for using the credential, a selected retailer(s)/merchant(s) at which the credential may be used, a time of day, or a loss of proximity between the first and second electronic devices. In one or more implementations, if any one or more conditions placed on the credential are not satisfied during use of the credential by the second electronic device, the credential may be removed, deactivated, or un-provisioned from the second electronic device.

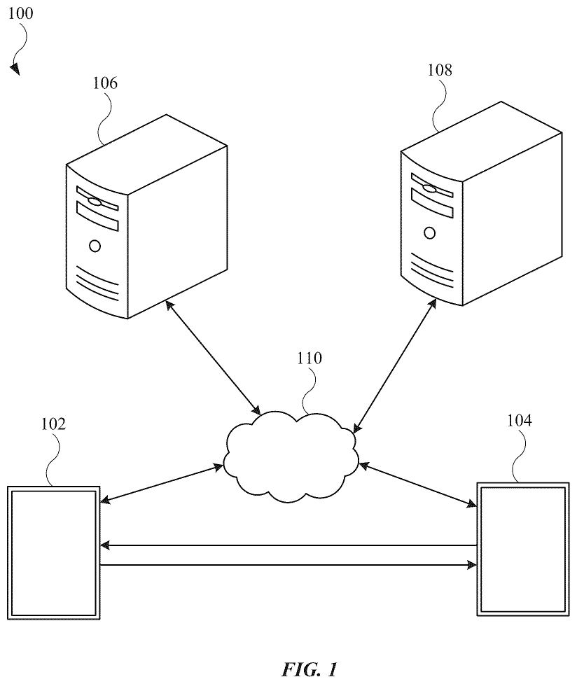

These and other embodiments are discussed below with reference to FIGS. 1-11. However, those skilled in the art will readily appreciate that the detailed description given herein with respect to these Figures is for explanatory purposes only and should not be construed as limiting.

FIG. 1 illustrates an example of a network environment 100 of a system in which a credential may be shared between devices, in accordance with aspects of the present disclosure. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

The network environment 100 may include an electronic device 102, an electronic device 104, a financial institution server 106, and a service provider server 108. The network environment 100 may further include a network 110 communicatively (directly or indirectly) coupled with one or more of the electronic device 102, the electronic device 104, the financial institution server 106, and the service provider server 108. In one or more implementations, the network 110 may be an interconnected network of devices that may include, or may be communicatively coupled to, the Internet. For explanatory purposes, the network environment 100 is illustrated in FIG. 1 as including the electronic device 102, the electronic device 104, the financial institution server 106, the service provider server 108, and the network 110. However, the network environment 100 may include any number of electronic devices and/or any number of servers communicatively coupled to each other directly or via the network 110.

Each of the electronic devices 102 and 104 may take the form of, for example, a wearable device such as a watch (or smartwatch), a portable computing device (e.g., a smartphone, a tablet device), or any other appropriate device that includes, for example, one or more wireless interfaces, such as WLAN radios, cellular radios, BLUETOOTH® radios, Zigbee radios, near field communication (NFC) radios, and/or other wireless radios. In FIG. 1, by way of example, each of the electronic devices 102 and 104 is depicted as a smartphone.

The financial institution server 106 may include a server functioning as a third-party network for a financial institution such as a bank, a virtual bank, a credit union, a credit card vendor, a gift card vendor, an investment firm, or a brokerage account, as non-limiting examples. Generally, the financial institution server 106 may include any entity that holds an account, on behalf of a user (e.g., a user of the electronic device 102), with one or more liquid assets that can be exchanged for goods and services. Additionally, the financial institution server 106 may be used for payment processing for one or more of the electronic devices 102 and 104. Further, a user may interact with the financial institution server 106 by one or more of a software application, or app, running on the electronic devices 102 and 104.

The service provider server 108 may facilitate management of a variety of digital assets for the electronic devices 102 and 104. For example, the service provider server 108 may facilitate provisioning a credential of a user on a secure element of the electronic device 102. As a non-limiting example, the credential may be associated with an account (e.g., credit card, debit card, or the like) owned or managed a user and stored on a digital wallet of the electronic device 102, such as in the form of a credential provisioned on a secure element of the electronic device 102. In one or more implementations, at least one of the financial institution server 106 and the service provider server 108 may provision the credential on the electronic device 102 by, for example, on a secure element of the electronic device 102. Similarly, at least one of the financial institution server 106 and the service provider server 108 may provision the credential on the electronic device 104 subject to authorization by the electronic device 102 and/or the user of the electronic device 102. Alternatively, the credential may correspond to a loyalty card, a coupon, a vehicle (e.g., unlocking a vehicle for access to the vehicle), or a residence (e.g., unlocking a door into the residence). Also, the service provider server 108 may store, on behalf of a user of the electronic device 102, a list one or more associated devices and/or their respective user accounts (e.g., the electronic device 104 and a user account associated with the electronic device 104), such as in the context of a family sharing group or any other group of devices and/or user accounts. In this regard, a user of the electronic device 102 may select, via the electronic device 102, from the list a user account and/or electronic device 104 to which the credential may be shared.

In one or more implementations, a user of the electronic device 102 may share a credential with the electronic device 104 in order to permit another user to use the electronic device 104 to perform a transaction using the credential. The electronic device 102 may receive a request from the electronic device 104 to access the credential. Alternatively, the electronic device 102 can provide an inactive and/or disabled version of the credential to the electronic device 104. In either event, when the electronic devices 102 and 104 are within proximity of each other, the electronic device 102 may authorize the credential on the electronic device 104, thus allowing the user of the electronic device 104 to perform the transaction.

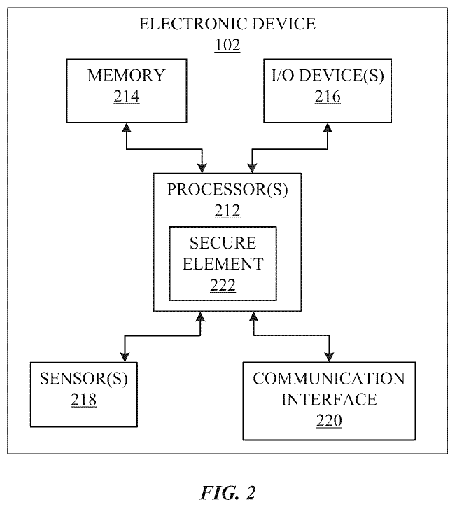

FIG. 2 illustrates a block diagram of an example of an electronic device 102 that may be used to provide and/or transact with a credential, in accordance with aspects of the present disclosure. The electronic device 102 shown in FIG. 2 may be implemented in any other electronic device for use with the subject technology. Variations in the arrangement and type of the components may be made without departing from the spirit or scope of the claims as set forth herein. Additional components, different components, or fewer components may be provided. Also, the electronic device 104 (shown in FIG. 1) may include any components and associated features shown and/or described for the electronic device 102.

The electronic device 102 may include one or more processors 212, a memory 214, one or more input-output devices 216 (I/O devices(s)), one or more sensors 218, a communication interface 220, and a secure element 222. The one or more processors 212 may include a central processing unit, a graphics processing unit, one or more microcontrollers, or a combination thereof. Further, the one or more processors 212 may include suitable logic, circuitry, and/or code that enable processing data and/or controlling operations of the electronic device 102. In this regard, the one or more processors 212 may be enabled to provide control signals to various other components of the electronic device 102. The one or more processors 212 may also control transfers of data between various portions of the electronic device 102. The one or more processors 212 may further implement an operating system or may otherwise execute code to manage operations of the electronic device 102. In one or more implementations, the one or more processors 212 may include a secure element 222 and/or a secure enclave processor. The one or more processors 212 are communicatively coupled to the various components shown in FIG. 2.

The memory 214 may include suitable logic, circuitry, and/or code that enable storage of various types of information such as received data, generated data, code, and/or configuration information. The memory 214 may include volatile memory (e.g., random access memory (RAM)) and/or non-volatile memory (e.g., read-only memory (ROM), flash, and/or magnetic storage). In one or more implementations, the memory 214 may store user account data, and any other data generated in the course of performing the processes described herein.

The one or more input-output devices 216 may include a display. In one or more implementations, the display includes a capacitive touch input display, thus allowing the user to interact with the electronic device 102 by a touch input or gesture to the display. Additionally, the one or more input-output devices 216 may include one or more buttons, which may be actuated by a user of the electronic device 102. The one or more input-output devices 216, while taking the form of a display and/or buttons, may be used to provide an input to the one or more processors 212 in order to, for example, initiate a payment through a payment provider. Further, the one or more input-output devices 216 may include an audio module (e.g., speaker) designed to convert electrical signals into soundwaves in the form of audible sound.

The one or more sensors 218 may include one or more microphones and/or cameras. The microphones may obtain audio signals, such as voice commands from a user to initiate or authorize or request a transaction using a credential. For example, the microphones may obtain audio of the user reading a passphrase or authentication code. The cameras may be used to capture images corresponding to identity data and/or credentials. For example, the cameras may capture images of a user (e.g., a selfie) for comparison against a database of images of users, may capture images of a user's identity credentials, such as driver's license, passport, etc., and/or may be used for a “liveness” determination.

The communication interface 220 may include suitable logic, circuitry, and/or code that enables wired or wireless communication, such as between the electronic device 102 and the network 110 (shown in FIG. 1). The communication interface 220 may include, for example, one or more of a BLUETOOTH® communication interface, an NFC interface, a Zigbee communication interface, a WLAN communication interface, a Universal Serial Bus (USB) communication interface, a cellular interface, or generally any communication interface. Accordingly, the communication interface 220 may establish a radio network, allowing the electronic device 102 to communicate with another device (e.g., the electronic device 104 shown in FIG. 1). In one or more implementations, electronic devices described herein may use respective communication interfaces to detect another electronic device and to determine whether the electronic devices are within proximity to each other.

The secure element 222 may include suitable logic, circuitry, and/or code that enables protection from unauthorized access and hacking attempts. The secure element 222 may store and process passwords, codes, biometric data (e.g., fingerprint data), and/or payment information, as non-limiting examples. Additionally, the secure element 222 may allow access from applications running on the electronic device 102, such as a digital wallet that stores a credential. Further, a credential may be provisioned on the secure element 222.

In one or more implementations, the one or more processors 212, the memory 214, the one or more input-output devices 216, the one or more sensors 218, the communication interface 220, the secure element 222, and/or one or more portions thereof may be implemented in software (e.g., subroutines and code), may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination of both.

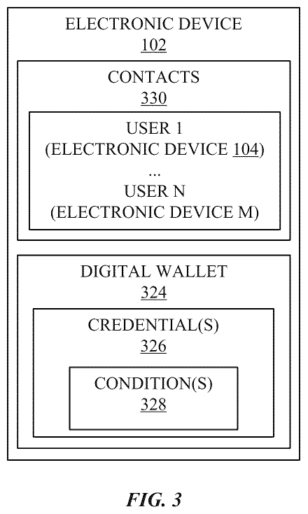

FIG. 3 illustrates a block diagram of an example of an electronic device 102 used to provide and/or share a credential, in accordance with aspects of the present disclosure. The electronic device 102 may include a digital wallet 324. The digital wallet 324 may be presented to the user on an I/O device, such as a display. As shown, the digital wallet 324 includes a credential 326 that may be store don the electronic device 102, such as on a secure element of the electronic device 102. Alternately or in combination, the credential 326 may be stored on a server (e.g., service provider server 108 shown in FIG. 1) and is accessible to a user of the electronic device 102 via the digital wallet 324. The credential 326 may be associated with an account owned or managed by a user of the electronic device 102. As non-limiting examples, the credential 326 may take the form of a payment account (e.g., credit card, debit card, or the like), a loyalty account (e.g., customer loyalty program), a coupon, a vehicle (e.g., unlocking a vehicle for access to the vehicle), or a residence (e.g., unlocking a door into the residence).

The credential 326 may be associated with the one or more conditions 328. The one or more conditions 328 may include restrictions placed on usage of the credential 326 by another device. As non-limiting examples, the one or more conditions 328 may include a transaction limit (e.g., spending limit) on the credential 326, a time duration (e.g., time limit) for using the credential 326, a selected retailer(s)/merchant(s) allowed for performing a transaction with the credential 326, a prohibited retailer(s)/merchant(s) that is/are prevented from being used for a transaction with the credential 326, a time of day (e.g., time window) for using the credential 326, and/or a loss of proximity between the electronic device 102 and the other device (e.g., the electronic device that receives the credential 326). In this regard, the credential 326 may take the form of a temporary credential when used by another device. The one or more conditions 328 may be set by a user of the electronic device 102, the issuing entity of the credential 326 (e.g., financial institution), or a combination thereof.

Additionally, the electronic device 102 may store contacts 330. The contacts 330 may include a list of users (e.g., known users) and one or more devices of the users. The user of the electronic device 102 may register the users and associated devices on a user account managed by, for example, the service provider server 108 (shown in FIG. 1). As shown, the contacts 330 include User 1 and the electronic device 104 is a device of User 1. Further, the contacts 330 include User N (representing a total of N users) and an electronic device M (representing a total of M devices). Alternately or in combination, the contacts 330 may be stored on a server (e.g., service provider server 108 shown in FIG. 1) and may be accessible to a user of the electronic device 102. In one or more implementations, the user of the electronic device 102 may select one or more users from the contacts 330, and in particular one or more devices of the user(s), to which the credential 326 may be provided. Moreover, by relying on the contacts 330 and associated devices, the user of the electronic device 102 may exercise more control over access to the credential 326 by another device. Put another way, in some instances, a device capable of receiving the credential 326 may initially be required to be registered and store as one of the contacts 330.

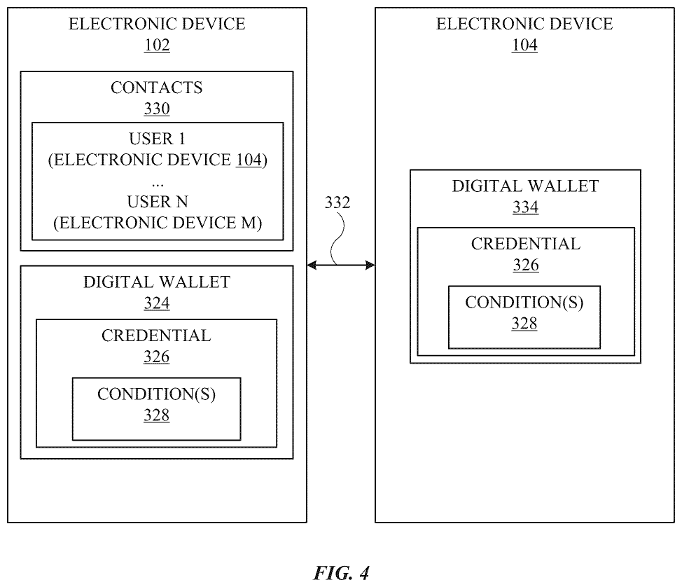

FIG. 4 illustrates a block diagram of an example of an electronic device 102 providing a credential 326 to an electronic device 104, in accordance with aspects of the present disclosure. In one or more implementations, the electronic device 104 may be required to be within proximity to the electronic device 102. In this regard, each of the electronic devices 102 and 104 may include a communication interface (e.g., communication interface 220 shown in FIG. 2) used to detect each other. When the electronic device 104 is within proximity of the electronic device 102, a wireless communication link 332 may be established between respective communication interfaces of the electronic devices 102 and 104. The required “proximity” may be based in part on the range associated with the protocol (e.g., BLUETOOTH®, NFC) of the communication interfaces. When the wireless communication link 332 is established, each of the electronic devices 102 and 104 may generate a respective notification indicating to users of the electronic devices 102 and 104 that the electronic devices 102 and 104 are in proximity to each other.

In one or more implementations, the wireless communication link 332 may represent an NFC transaction that is performed between the electronic device 102, 104, such as by performing a tap gesture with one of the electronic devices and/or otherwise bringing the electronic devices within a close proximity. In one or more implementations, the electronic devices 102, 104 may perform one or more ranging operations to determine and/or confirm that the electronic devices are within a particular proximity.

In one or more implementations, the electronic device 104 may send a request to the electronic device 102 to access, or to obtain access, to the credential 326. The request may be provided via the wireless communication link 332 or through a network (e.g., network 110 shown in FIG. 1). Based on the request, the electronic device 102 may generate a notification and present the notification on a display for the user of the electronic device 102 to review. Upon approval by the user, the electronic device 102 may provide the credential 326 to the electronic device 104. Further, the credential 326 may be provisioned on a secure element (e.g., secure element 222 shown in FIG. 2) of the electronic device 104. As shown, the electronic device 104 may include a digital wallet 334 that stores the credential 326. In some instances, the electronic device 102 may provide the credential 326 to the electronic device 104 only when the electronic devices 102 and 104 are in proximity to each other.

In one or more implementations, the proximity between the electronic devices 102 and 104 may be used to establish permission by the electronic device 102 and initiate an activated credential (e.g., credential 326) for the electronic device 104 to perform the transaction. However, in some instances, additional authorization in the form of credential activation information may be used to generate an activated credential. For example, when the credential 326 is associated with account that includes a verification value (e.g., credit card with a credential verification value, or CVV), the electronic device 104 may require the verification value in order to generate an activated credential 326 for a transaction. Prior to or during a transaction using the credential 326, the user of the electronic device 104 may provide, via the electronic device 104, a request for the verification value, to the electronic device 102. The electronic device 102 may provide a notification to the user of the electronic device 102, and the user of the electronic device 102 may authorize and provide, via the electronic device 102, the verification value to the electronic device 104 in order to complete the transaction using the credential 326. In some instances, the verification value is transmitted via the wireless communication link 332 when the electronic devices 102 and 104 are in proximity to each other. Other example of credential activation information may include a token or key required to access the credential 326. The token or key may be provided by the electronic device 102 to the electronic device 104.

When applied, the one or more conditions 328 of the credential 326 may restrict usage of the credential 326 by the electronic device 104. For example, the one or more conditions 328 of the credential 326 may set a transaction limit for the electronic device 104 when using the credential 326. Moreover, in one or more implementations, when the electronic device 104 attempts to perform a transaction using the credential 326 that does not satisfy of the one or more conditions 328, the transaction may be revoked and the credential 326 may be removed, un-provisioned, or otherwise placed in an inactive state (e.g., deactivated).

In some instances, the user of the electronic device 104 may request permission to the user of the electronic device 102 to perform the transaction using the credential 326 that would otherwise not satisfy of the one or more conditions 328. For example, when the electronic device 104 uses the credential 326 to perform a transaction that exceeds the transaction limit, the user of the electronic device 104 may send, via the electronic device 104, a request to the electronic device 102 for the user of the electronic device 102 to override the transaction limit. In response, of the electronic device 102 may provide, via the electronic device 102, an authorization to the electronic device 104 to override the transaction limit imposed by the one or more conditions 328, thereby allowing the electronic device 104 to perform the transaction with the credentials 326. As non-limiting examples, overriding a nonsatisfaction of the one or more conditions 328 may include a blanket override that removes the one or more conditions 328 or limited override (e.g., transaction limit increase from $10 to $20). Alternatively, when the electronic device 104 uses the credential 326 to perform a transaction, the transaction may effectively be pre-approved by the electronic device 102 provided the transaction satisfies each of the one or more conditions 328.

In one or more implementations, the credential 326 may be provided, or at least partially provided, on the electronic device 104 prior to a request by a user of the electronic device 104. For example, a portion of the credential 326 may be provisioned on the electronic device 104, such as responsive to a request by the user of the electronic device 102. In some instances, the portion of the credential 326 may be inactive, disabled, and/or inaccessible by a user of the electronic device 104. In this regard, the user may not have knowledge of the received portion of the credential stored on the electronic device 104. Subsequently, when the electronic devices 102 and 104 are in proximity to each other, the user of the electronic device 102 may provide, via the electronic device 102, an additional portion of the credential 326 to the electronic device 104. Based on the portion and additional portion of the credential 326 being received by the electronic device 104, the credential may transition to an active state and the electronic device 104 may be used to perform a transaction using the credential 326. For example, the additional portion of the credential 326 may be used by the secure element of the electronic device 104 to activate the credential.

In one or more implementations, the electronic device 102 may approve the transaction by the electronic device 104 using the credential 326 prior to completion of the transaction. For example, the electronic device 104 may include an I/O device such as a camera. The I/O device may capture an image that includes at least some transaction details, such as the amount and/or the retailer/merchant of the desired transaction. The electronic device 104 may provide the image to the electronic device 102, and the electronic device 102 may present the image to a user of the electronic device 102 for review. Upon approval by the user based on approval the transaction details provided by the image, the electronic device 102 may provide authorization to the electronic device 104 to complete the transaction using the credential 326. Alternatively, the I/O device may include a microphone that allows the user of the electronic device 104 to provide a passcode. In this regard, the electronic device 102 may include an I/O device that takes the form of an audio module used to generate soundwaves corresponding to the passcode. The electronic device 102 and/or the user of the electronic device 102 may authorization the transaction based on the received passcode.

Also, in some instances, the user of the electronic device 104 does not own an account associated with the credential 326. However, provided the electronic device 104 obtains authorization by the electronic device 102 to use the credential 326, the electronic device 104 may nonetheless perform the transaction. Beneficially, the user of the electronic device 104 may not be required to establish an account (e.g., account associated with the credential 326) while still being able to utilize the credential 326 for a transaction.

While two exemplary electronic devices (e.g., the electronic devices 102 and 104) are described, additional electronic devices may be used. For example, one or more devices in addition to the electronic device 102 may be used to authorize use of a credential, including providing the credential, to another device. For example, a family with parents and children within a defined group (e.g., contacts 330) may specify that account holders (e.g., parents) of an account associated with the credential 326 may provide and authorize use of the credential 326 to a respective device of one or more of the children.

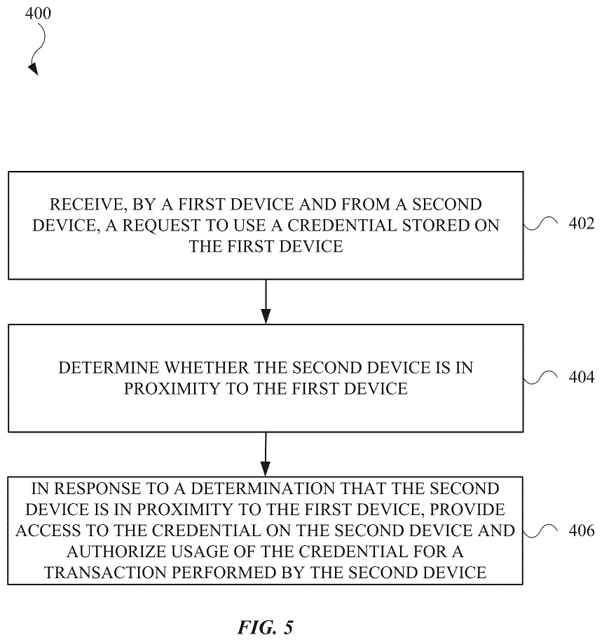

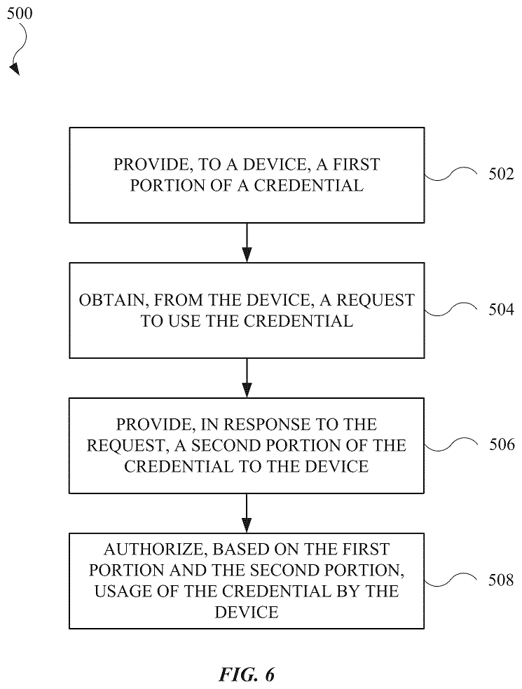

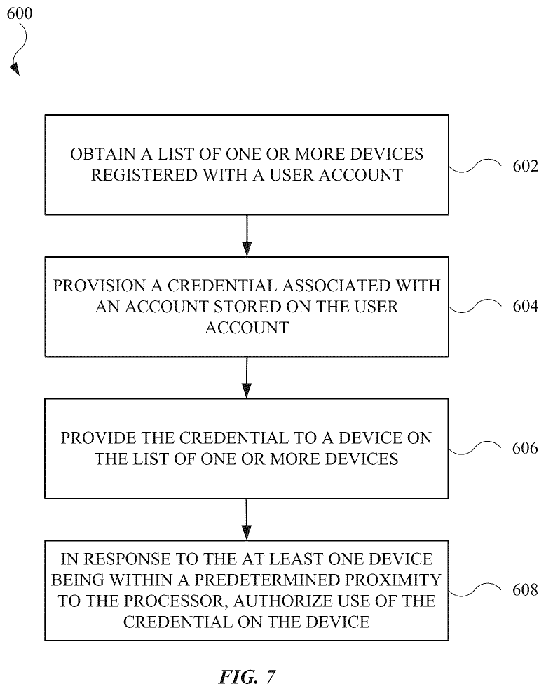

FIG. 5, FIG. 6, and FIG. 7 illustrate flow diagrams showing examples of one or more processes that may be performed for providing a credential to a device, in accordance with implementations of the subject technology. One or more electronic devices (e.g., electronic devices 102 and 104) may be used in part to conduct one or more steps of the example processes. For explanatory purposes, the respective processes shown in FIGS. 5-7 are primarily described herein with reference to the electronic devices 102 and 104, which may include a smartphone. However, the respective processes shown in FIGS. 5-7 are not limited to the electronic devices 102 and 104, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 5 illustrates a flow diagram showing an example of a process 400 that may be performed for providing access to a credential for a device, in accordance with implementations of the subject technology.

At block 402, a first device receives a request from a second device to use a credential stored on the first device. The credential may be associated with an account owned or managed by a user of the first device. Further, the credential may be stored on a digital wallet of the first device and provisioned on a secure element of the first device. Also, both the second device and a user of the second device may be stored by the first electronic device on a list of one or more users and one or more devices.

At block 404, a determination is made whether the second device is in proximity to the first device. Each of the first device and the second device may include a communication interface that allows the first device and the second device to communicate and exchange information. When the first device and the second device are within the transmission range of their communication interfaces, a determination may be made that the first device and the second device are in proximity to each other. The transmission range may be based in part on the communication protocol of the communication interfaces.

At block 406, in response to a determination that the second device is in proximity to the first device, access is provided to the credential on the second device and usage of the credential is authorized for a transaction performed by the second device. A user of the second device with an authorized credential may be referred to as an authorized user. In order for the second to use the credential to perform the transaction, an instance of the credential may be provisioned on the second device. In one or more implementations, the credential includes one or more conditions. In this regard, the credential may take the form of a temporary credential.

FIG. 6 illustrates a flow diagram showing an alternate example of a process 500 that may be performed for providing access to a credential for a device, in accordance with implementations of the subject technology.

At block 502, a first portion of a credential is provided to a device. The first portion may be stored on the device in an inactive and/or inaccessible state. In this regard, a user of the device may be prohibited from using the credential based on the first portion alone. For example, the first portion of the credential may be missing a cryptogram associated with the CVV code of the credential.

At block 504, a request from the device is obtained to use the credential. A user of the device may generate the request.

At block 506, a second portion of the credential is provided to the device. The second portion of the credential may represent a remaining portion of the credential, such as a cryptogram generated by input of the CVV of the credential by the user of the device providing the second portion of the credential.

At block 508, based on the first portion and the second portion, usage of the credential by the device is authorized. In this regard, the credential may be active and accessible by a user of the device to perform a transaction on the device. In one or more implementations, the first and second portions may be combined to activate or complete the credential.

FIG. 7 illustrates a flow diagram showing an alternate example of a process 600 that may be performed for providing access to a credential for a device, in accordance with implementations of the subject technology.

At block 602, a list of one or more devices registered with a user account is obtained. Each device of the one or more devices on the list may be registered with a user of the device and stored on the user account. Further, each user (and/or user account) of the one or more devices may also be registered on the user account.

At block 604, a credential associated with an account stored on the user account is provisioned. The credential may be provisioned on a secure element of a system (e.g., electronic device).

At block 606, the credential is provided to a device on the list of one or more devices. Using the system, a user may select the device to which the credential is provided.

At block 608, in response to the at least one device being within a predetermined proximity to the processor, use of the credential on the device is authorized. Each of the system and the device may include a communication interface that allows the system and the device to communicate and exchange information. When the system and the device are within the transmission range of their communication interfaces, a determination is made that the system and the device are in proximity to each other. The transmission range may be based in part on the communication protocol of the communication interfaces.

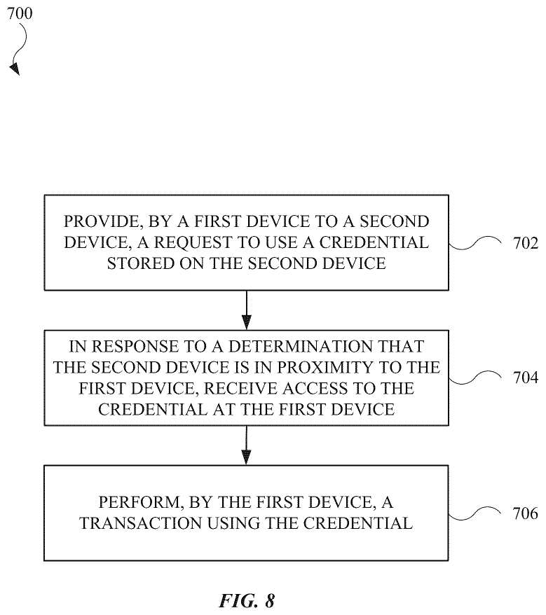

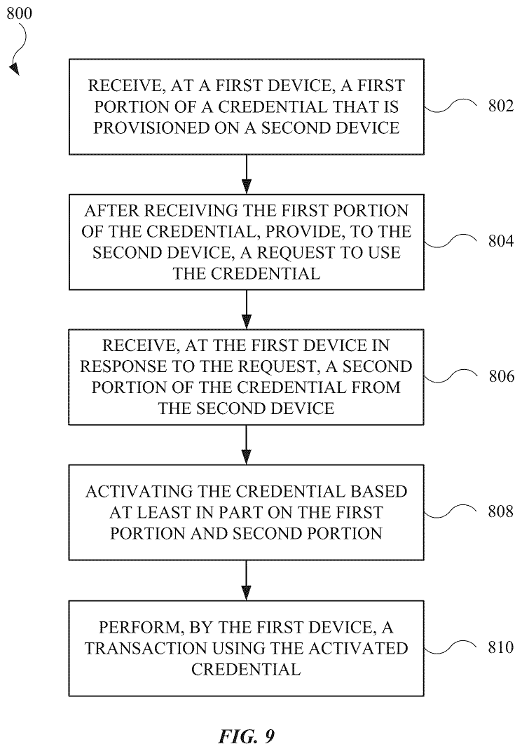

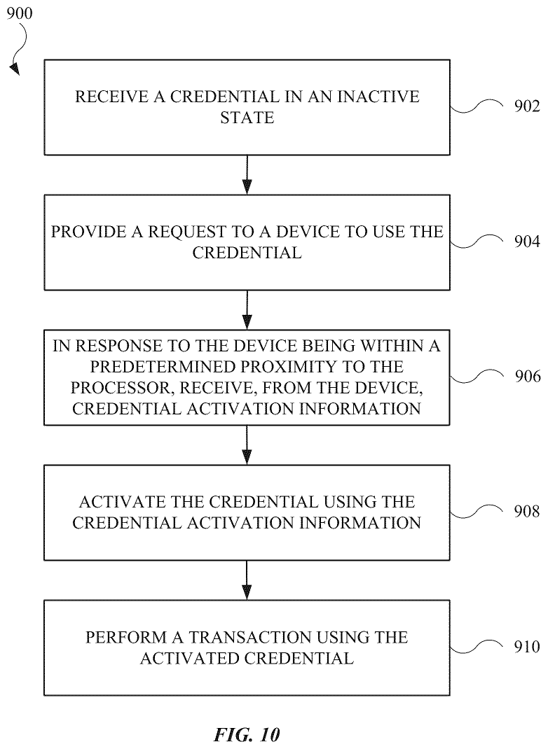

FIG. 8, FIG. 9, and FIG. 10 illustrate flow diagrams showing examples of one or more processes that may be performed for obtaining and/or accessing a credential from a device, in accordance with implementations of the subject technology. One or more electronic devices (e.g., electronic devices 102 and 104) may be used in part to conduct one or more steps of the example processes. For explanatory purposes, the respective processes shown in FIGS. 8-10 are primarily described herein with reference to the electronic devices 102 and 104, which may include a smartphone. However, the respective processes shown in FIGS. 8-10 are not limited to the electronic devices 102 and 104, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 8 illustrates a flow diagram showing an example of a process 700 that may be performed for obtaining access to a credential for an electronic device, in accordance with implementations of the subject technology.

At block 702, a first device provides a request to a second device to use a credential stored on the second device. The credential may be provisioned on a secure element of the second device.

At block 704, in response to a determination that the second device is in proximity to the first device, the first device receives access to the credential. When the first device gains access to the credential, the first device has a provisioned instance of the credential for use. Each of the first device and the second device may include a communication interface that allows the first device and the second device to communicate and exchange information. When the system and the device are within the transmission range of their communication interfaces, a determination is made that the system and the device are in proximity to each other. The transmission range may be based in part on the communication protocol of the communication interfaces.

At block 706, the first device performs a transaction using the credential. The transaction may include a payment-based transaction, as a non-limiting example. In this regard, the credential may be provisioned on a secure element of the first device.

FIG. 9 illustrates a flow diagram showing an alternate example of a process 800 that may be performed for obtaining access to a credential for an electronic device, in accordance with implementations of the subject technology.

At block 802, a first portion of a credential is received at a first device. The credential may be provisioned on a second device, and in particular, the credential may be provisioned on a secure element of the second device.

At block 804, after receiving the first portion of the credential, a request to use the credential is provided to the second device. A user may use the first device to generate the request to the second device.

At block 806, in response to the request received by the first device, a second portion of the credential is received by the first device from the second device. The second portion may represent a remaining portion of the credential.

At block 808, the credential is activated on the first device based at least in part on the first portion and second portion. In one or more implementations, the credential is activated based on provisioning an instance of the credential on the first device.

At block 810, a transaction is performed using the activated credential. The transaction may be performed by the first device. In one or more implementations, the transaction is authorized based in part on proximity between the first device and the second device.

FIG. 10 illustrates a flow diagram showing an alternate example of a process 900 that may be performed for obtaining access to a credential for an electronic device, in accordance with implementations of the subject technology.

At block 902, a credential in an inactive state is received. In one or more implementations, the credential is inaccessible on a device based in part on the inactive state.

At block 904, a request is provided to a device to use the credential. The request may be provided by a user based on interacting with a device on which the credential in the inactive state is stored.

At block 906, in response to the device being within a predetermined proximity to the processor, credential activation information is received from the device. The credential activation information may include a verification value. Alternatively or in combination, the credential activation information may include an acknowledgement that the device in proximity to a device on which the credential in the inactive state is stored.

At block 908, the credential is activated using the credential activation information. Based on the credential activation information, the credential may transition from the inactive state to an active state.

At block 910, a transaction is performed using the activated credential. As a non-limiting example, the transaction may include a payment-based transaction.

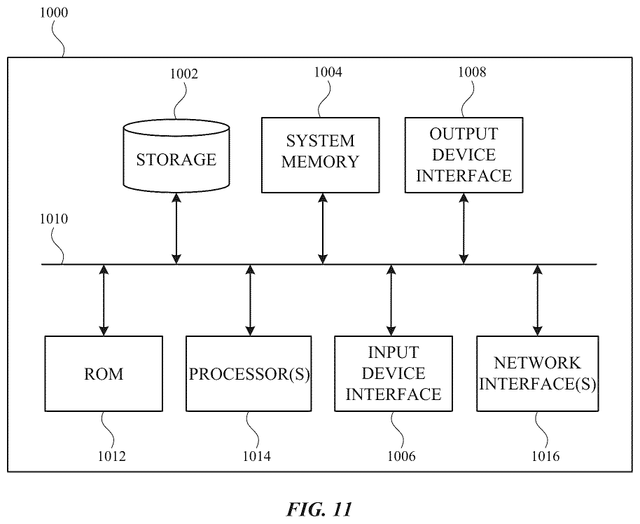

FIG. 11 illustrates an electronic system 1000 with which one or more implementations of the subject technology may be implemented. The electronic system 1000 can be, and/or can be a part of, the electronic device 102 or the electronic device 104 as shown in FIG. 1. The electronic system 1000 may include various types of computer readable media and interfaces for various other types of computer readable media. The electronic system 1000 includes a bus 1010, one or more processing units 1014, a system memory 1004 (and/or buffer), a ROM 1012, a permanent storage device 1002, an input device interface 1006, an output device interface 1008, and one or more network interfaces 1016, or subsets and variations thereof.

The bus 1010 collectively represents all system, peripheral, and chipset buses that communicatively connect the numerous internal devices of the electronic system 1000. In one or more implementations, the bus 1010 communicatively connects the one or more processing units 1014 with the ROM 1012, the system memory 1004, and the permanent storage device 1002. From these various memory units, the one or more processing units 1014 retrieves instructions to execute and data to process in order to execute the processes of the subject disclosure. The one or more processing units 1014 can be a single processor or a multi-core processor in different implementations.

The ROM 1012 stores static data and instructions that are needed by the one or more processing units 1014 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing units 1014 may need at runtime. In one or more implementations, the processes of the subject disclosure are stored in the system memory 1004, the permanent storage device 1002, and/or the ROM 1012 (which are each implemented as a non-transitory computer-readable medium). From these various memory units, the one or more processing units 1014 retrieves instructions to execute and data to process in order to execute the processes of one or more implementations.

The bus 1010 also connects to the input device interface 1006 and output device interface 1008. The input device interface 1006 enables a user to communicate information and select commands to the electronic system 1000. Input devices that may be used with the input device interface 1006 may include, for example, alphanumeric keyboards and pointing devices (also called “cursor control devices”). The input device interface 1006 may enable, for example, the display of images generated by electronic system 1000. Output devices that may be used with the input device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1010 also couples the electronic system 1000 to one or more networks and/or to one or more network nodes, such as the electronic devices 102 and 104 shown in FIG. 1, through the one or more network interfaces 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As described above, one aspect of the present technology is the gathering and use of data available from specific and legitimate sources for providing or obtaining a credential from an electronic device. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for providing or obtaining a credential from an electronic device.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing or obtaining a credential from an electronic device, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving, by a first device and from a second device, a request to use a credential stored on the first device;
determining whether the second device is in proximity to the first device; and
in response to a determination that the second device is in proximity to the first device, providing access to the credential on the second device and authorizing usage of the credential for a transaction performed by the second device.

2. The method of claim 1, wherein providing the access to the credential comprises provisioning an instance of the credential on the second device.

3. The method of claim 1, further comprising providing, over a network used to determine the second device is in proximity to the first device, a verification value associated with the credential.

4. The method of claim 1, further comprising storing, by the first device, a list of one or more devices comprising the second device.

5. The method of claim 1, wherein providing the access to the credential comprises receiving, by the first device from a third-party network, information for provisioning an instance the credential on the second device.

6. The method of claim 1, wherein the credential comprises a temporary credential that includes at least one of a time limit for using the credential by the second device, a spending limit for using the credential by the second device, or a transaction limit for the credential by the second device.

7. The method of claim 1, further comprising prior to receiving the request, provisioning an instance of the credential on the first device.

8. The method of claim 1, wherein the transaction comprises a payment-based transaction.

9. A non-transitory computer-readable medium, comprising:
computer-readable instructions that, when executed by a processor, cause the processor to perform one or more operations comprising:
providing, to a device, a first portion of a credential;
obtaining, from the device, a request to use the credential;
providing, in response to the request, a second portion of the credential to the device; and
authorizing, based on the first portion and the second portion, usage of the credential by the device.

10. The non-transitory computer-readable medium of claim 9, providing the first portion and the second portion comprises provisioning an instance of the credential on the device.

11. The non-transitory computer-readable medium of claim 9, further comprising:
determining whether the device is in proximity to the processor; and
in response to a determination that the device is in proximity to the processor, providing the second portion.

12. The non-transitory computer-readable medium of claim 9, wherein:
the credential comprises one or more conditions, and
the one or more conditions comprise at least one of a time limit for using the credential by the device, a spending limit for using the credential by the device, or a transaction limit for the credential by the device.

13. The non-transitory computer-readable medium of claim 12, further comprising in response to a determination of a nonsatisfaction of the one or more conditions by the device, removing the credential on the device.

14. The non-transitory computer-readable medium of claim 12, further comprising:
providing, in response a nonsatisfaction by the device of the one or more conditions by the device based on performing a transaction, obtaining, from the device, a second request override the nonsatisfaction; and
providing, to the device, an authorization to override the nonsatisfaction, thereby allowing the device to use the credential for the transaction.

15. The non-transitory computer-readable medium of claim 9, further comprising:
determining whether a user of the device is an authorized user; and
in response to a determination that the user is an authorized user, providing the second portion.

16. A system, comprising:
a memory;
a secure element; and
a processor configured to:
obtain a list of one or more devices registered with a user account;
provision a credential on the secure element, wherein the credential is associated with an account stored on the user account;
provide the credential to a device on the list of one or more devices; and
in response to the device being within a predetermined proximity to the processor, authorize use of the credential on the device.

17. The system of claim 16, wherein the processor is further configured to provide, based on a provisioning of an instance of the credential, usage of the credential by the device.

18. The system of claim 16, wherein the processor is further configured to obtain, from a network, the list of one or more devices, wherein the user account is stored on the network.

19. The system of claim 16, wherein the predetermined proximity is based on a radio network configured to detect the device.

20. The system of claim 16, wherein in response to the device not being within the predetermined proximity to the processor, the processor is further configured to maintain the credential inactive for use by the device.
